(19) United States
(12) Patent Application Publication
(10) Pub. No.: US 2009/0085542 A1
(43) Pub. Date: Apr. 2, 2009

(54) DRIVE SYSTEM FOR POWER SEMICONDUCTOR DEVICE

(75) Inventors: Masaru Numano, Saitama-ken (JP); Shigeyuki Sakura, Kanagawa-ken (JP); Yasuzumi Hirao, Kanagawa-ken (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/236,570

(22) Filed: Sep. 24, 2008

(30) Foreign Application Priority Data
Sep. 27, 2007 (JP) 2007-250795
Feb. 6, 2008 (JP) 2008-026534

(51) Int. Cl. G05F 1/56

(52) U.S. Cl. 323/282

(57) ABSTRACT

An output signal from a driver is provided to an output unit which includes first and second transistors to output a drive signal for driving a power device. A control signal is supplied from a control signal supply. The control signal indicates an enabled state and a disabled state to control the first and second transistors. The control signal is provided to a voltage output circuit. An output signal from the voltage output circuit is provided to a voltage hold circuit. The first and second transistors are turned off by a disable circuit when the control signal is in the disabled state. A shutdown circuit operates to draw out current from an output terminal of the output unit based on a signal provided from the voltage hold circuit and the control signal when the control signal is in the disabled state.

### CROSS REFERENCE TO RELATED APPLICATION

This application is based upon and claims the benefit of priority from the prior Japanese Patent Application No. 2007-250795, filed on Sep. 27, 2007, and No. 2008-26534, filed on Feb. 6, 2008, the entire contents of which are incorporated herein by reference.

### FIELD OF THE INVENTION

The present invention relates to a drive system for driving a power semiconductor device such as a power transistor.

### DESCRIPTION OF THE BACKGROUND

A power device such as an insulated gate bipolar transistor (IGBT) or a power MOS transistor is used to switch current supplied to a motor and the like. When the power device is turned of abruptly upon occurrence of abnormality such as load shorting, the power device serving as a load may be damaged or destroyed.

A power device drive system capable of soft shutdown is used as a means for avoiding such a risk. Such a type of power device drive system is disclosed in Japanese Patent Application Publication (Kokai) No. 2006-295326.

The above patent publication shows that power devices such as IGBTs are switched to supply current to coils of respective phases of a poly-phase motor.

When the power device drive system detects an abnormality, the power device drive system shuts down the power devices gradually by using a soft shutdown circuit. As a result, destroy of the power devices can be prevented.

In the power device drive system, external resistances are provided between output terminals of the power device drive system and the power devices.

Accordingly, signal lines connecting the output terminals and the power devices cannot be reduced in length. In other words, provision of such external resistances or external transistors prevents miniaturizing the power device drive system.

### SUMMARY OF THE INVENTION

An aspect of the present invention provides a power device drive system for switching a power device which includes a driver unit that includes a driver and an output unit, the driver receiving an input signal for switching the power device so as to output a driver output signal, the output unit being connected between a higher voltage supply and a lower voltage supply, the output unit having first and second transistors connected in cascade, the first and second transistors being controlled according to the driver output signal to output a drive signal for driving the power device, a control signal supply portion to supply a control signal for indicating an enabled state and a disabled state so as to control the first and second transistors, a disable circuit to turn off the first and second transistors when the control signal from the control signal supply portion is in the disabled state, a voltage output circuit to receive the control signal from the control signal supply portion so as to output a first signal for providing voltage according to the control signal, a voltage hold circuit to receive the first signal outputted from the voltage output circuit and a signal corresponding to the control signal, the voltage hold circuit holding a voltage of the first signal to output a second signal of the held voltage when the control signal is in the disabled state, and a shutdown circuit to receives the second signal outputted from the voltage hold circuit and a third signal obtained by inverting the control signal when the control signal is in the disabled state, the shutdown circuit drawing out current from an output terminal of the output unit while the second signal is supplied from the voltage hold circuit.

An aspect of the present invention provides a power device drive system for switching a power device which includes a driver unit having a driver and an output unit, the driver receiving an input signal for switching the power device so as to output a driver output signal, the output device being connected between a higher voltage supply and a lower voltage supply, the output device having first and second transistors connected in cascade, the first and second transistors being controlled according to the driver output signal so as to output a drive signal for driving the power device, a control signal supply portion to supply a control signal for controlling the first and second transistors, a voltage output circuit to output voltage according to the control signal from the control signal supply portion, an A/D converter circuit to rank the voltage obtained from the voltage output circuit according to the level of the voltage, the A/D converter circuit converting the voltage into a digital signal corresponding to the rank, a memory circuit to hold the digital signal upon receipt of a trigger signal while the digital signal is received, a shutdown circuit having shutdown resistances to be selected based on the digital signal held in the memory circuit, the shutdown circuit executing shutdown of the power device by connecting selected one of the shutdown resistances between an output terminal of the output unit and the lower voltage supply electrically.

### BRIEF DESCRIPTION OF THE DRAWING

FIG. 1 is a circuitry diagram showing a power device drive system according to a first embodiment of the present invention.

FIG. 2 is a drawing showing operation of the power device drive system of the first embodiment when a control signal is in an enabled state.

FIG. 3 is a drawing showing soft shutdown operation of the power device drive system of the first embodiment when the control signal is in a disabled state.

FIG. 4 is a circuitry diagram showing a power device drive system according to a second embodiment of the present invention.

FIG. 5 is a circuitry diagram showing a peak hold circuit.

FIG. 6 is a circuitry diagram showing a power device drive according to a third embodiment of the present invention.

FIG. 7 is a circuitry diagram to illustrate operation to be performed when an abnormality is detected, according to the third embodiment.

FIG. 8 is a circuitry diagram showing a power device drive system according to a fourth embodiment of the present invention.

### DETAILED DESCRIPTION OF THE INVENTION

Embodiments of the present invention will be described hereinafter with reference to the accompanying drawings.

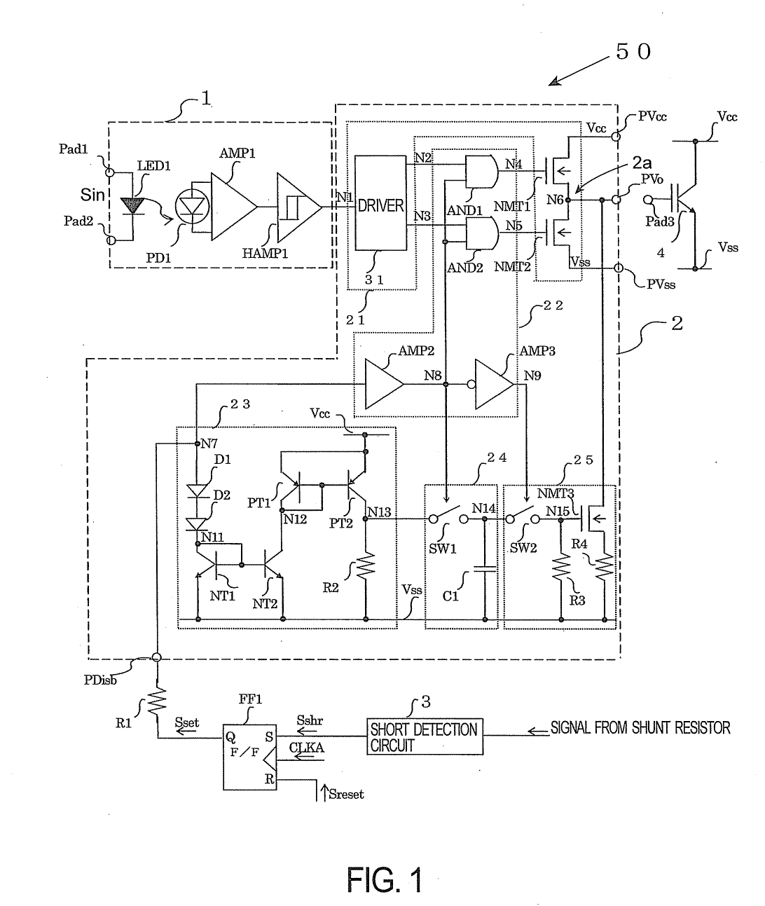

A power device drive system according to a first embodiment of the present invention will be described with reference to FIG. 1. FIG. 1 is a circuitry diagram showing a power device drive system according to the first embodiment of the present invention.

Electric current is supplied to coils of respective phases of a poly-phase motor by switching power devices, such as IGBTs, which constitutes an inverter. A structure of a power device drive system 50 for one phase will be described as a representative example hereinafter. Power device drive systems for the other phases have a similar structure.

In FIG. 1, the power device drive system 50 performs switching of an IGBT 4 to supply a current to a coil of a poly-phase motor. The power device drive system 50 and the IGBT 4 constitute a motor drive apparatus. An optical coupling unit 1 and a power device drive circuit unit 2 are provided in the power device drive system 50. Such a power device drive system is called as a driver IC coupler. The power device drive system 50 may be used in a hybrid electric vehicle (HEV) or an intelligent power module (IPM) for motor control.

The optical coupling unit 1 is provided with an amplifier AMP1, a hysteresis amplifier HAMP1, a light emitting diode LED1 as a light emitting device, a photo-receiving diode PD1 as a light receiving device, and terminals Pad1 and Pad2.

An anode of the light emitting diode LED1 is connected to the terminal Pad1. A cathode of the light emitting diode LED1 is connected to the terminal Pad2. The light emitting diode LED1 converts an electric signal Sin applied between the terminal Pad1 and the terminal Pad2 into a light signal.

The photo-receiving diode PD1 is provided between the light emitting diode LED1 and the amplifier AMP1. An anode of the photo-receiving diode PD1 is connected to one input terminal of the amplifier AMP1. A cathode of the photo-receiving diode PD1 is connected to the other input terminal of the amplifier AMP1. The photo-receiving diode PD1 converts the light signal generated in the light emitting diode LED 1 into an electric signal. In the optical coupling unit 1, signals are transmitted with the light emitting diode LED1 and the photo-receiving diode PD1 which are electrically insulated from each other to enable stable operation of the power device drive system 50.

The power device drive system 50, which is provided with the optical coupling unit 1, may be mounted in a surface mount type package, for example, and may be called as an optical coupling device. The power device drive circuit 2 can be integrated in a circuit. The power device drive system may be further reduced in size by integrating the power device drive circuit 2 and the photo-receiving diode PD1 in one chip.

The amplifier AMP1 is connected between the photo-receiving diode PD1 and the hysteresis amplifier HAMP1. The amplifier AMP1 amplifies the electric signal generated in the photo-receiving diode PD1. The hysteresis amplifier HAMP1 is called as a Schmitt amplifier. The hysteresis amplifier HAMP1 has a predetermined hysteresis width. A signal outputted from the amplifier AMP1 is inputted into the hysteresis amplifier HAMP1. The hysteresis amplifier HAMP1 removes noise components of the signal outputted from the amplifier AMP1. The hysteresis amplifier HAMP1 outputs an amplified electric signal to a node N1.

The power device drive circuit unit 2 is provided with a driver unit 21, a disable circuit 22, an I/V (current/voltage) converter circuit 23, a sample hold circuit 24, a soft shutdown circuit 25 as a shutdown circuit, a control terminal PDisb, a Vcc terminal PVcc, a Vo terminal PVo, and a Vss terminal PVss. The Vss terminal PVss is given a ground potential, for example. The control terminal PDisb constitutes a control signal supply portion.

The driver unit 21 is provided with a driver 31 and cascade-connected N-channel MOS transistors NMT1 and NMT2. The N-channel MOS transistors NMT1 and NMT2 comprise an output unit 2a.

The signal of the node N1 outputted from the hysteresis amplifier HAMP1 is inputted to the driver 31 as an input signal. The driver 31 outputs a first driver output signal to a node N2 and a second driver output signal to a node N3. Here, signals of the nodes N1 and N2 are in phase with each other and in reverse phase to a signal of the node N3.

A drain of the N-channel MOS transistor NMT1 is connected to the Vcc terminal PVcc as a higher voltage supply. A gate of the N-channel MOS transistor NMT1 is connected to a node 4. A source of the N-channel MOS transistor NMT1 is connected to a node N6. The N-channel MOS transistor NMT1 is called as a high-side transistor. A relatively high-voltage MOS transistor is used for the N-channel MOS transistor NMT1.

A drain of the N-channel MOS transistor NMT2 is connected to the node N6. A gate of the N-channel MOS transistor NMT2 is connected to a node N5. A source of the N-channel MOS transistor NMT2 is connected to the Vss terminal PVss. The N-channel MOS transistor NMT2 is called as a low-side transistor. A relatively high-voltage MOS transistor is used for the N-channel MOS transistor NMT2.

The N-channel MOS transistors NMT1 and NMT2 are connected between a higher voltage supply Vcc and a lower voltage supply (ground potential) Vss, and output an output signal to the Vo terminal PVo through the node N6.

The Vo terminal PVo is connected to an external terminal Pad3 through a signal line (not shown). A gate of the IGBT (Insulated Gate Bipolar Transistor) 4 as a power device is connected to the terminal Pad3. A collector of the IGBT 4 is connected to the higher voltage supply Vcc. An emitter of the IGBT 4 is connected to the lower voltage supply (ground potential) Vss.

In the power device drive system 50 of the embodiment, neither an external resistance nor an external transistor is connected to the signal line which connects the Vo terminal PVo and the terminal Pad3. This allows a gate line of the IGBT 4 to be shortened.

The disable circuit 22 is provided with an amplifier AMP2, an amplifier AMP3, and two-input AND circuits AND1 and AND2.

The amplifier AMP2 is connected between a node N7 and a node N8. The node N7 is connected to the control terminal PDisb. A control signal Sset is inputted into the amplifier AMP2 via the control terminal PDisb. The control signal Sset is a signal for controlling the ON/OFF of the N-channel MOS transistors NMT1 and NMT2 in the output unit 2a.

The amplifier AMP2 outputs a signal obtained by amplifying the control signal Sset to the node N8. The amplifier AMP3 is connected between the node N8 and a node N9. A signal of the node N8 is inputted into the amplifier AMP3. The amplifier AMP3 reverse-amplifies the signal of the node N8 and outputs the reverse-amplified signal from the node N9.

The two-input AND circuit AND1 is provided between the nodes N2 and N8 and the node N4. The two-input AND circuit AND1 outputs a logically-operated signal to the node N4. When both the node N2 and the node N8 are at “High” level, a signal of the node N4 will be at “High” level. Otherwise, the signal will be at “Low” level.

The two-input AND circuit AND2 is provided between the nodes N3 and N8 and the node N5. The two-input AND circuit AND2 outputs a logically-operated signal to the node N5. When both the node N3 and the node N8 are at “High” level, a signal of the node N5 will be at “High” level. Otherwise, the signal will be at “Low” level.

The disable circuit 22 turns “OFF” the N-channel MOS transistors NMT1 and NMT2 when the control signal Sset is in disabled state (at “Low” level).

A resistance R1, a flip-flop FF1, and a short detection circuit 3 are connected to the control terminal PDisb. The resistance R1, a flip-flop FF1, and a short detection circuit 3 are components to be externally attached to the power device drive system 50. The flip-flop FF1 is connected between the short detection circuit 3 and the resistance 1. The resistance R1 is connected between the flip-flop FF1 and the control terminal PDisb.

The short detection circuit 3 receives a signal from a shunt resistance (not shown) provided in an inverter of the motor. The short detection circuit 3 outputs a short signal Sshr. When an abnormality such as load shorting has occurred, the short signal Sshr is at “Low” level. Otherwise, the short signal Sshr is at “High” level.

The short signal Sshr outputted from the short detection circuit 3 is inputted into an S port of the flip-flop FF1. The flip-flop FF1 latches input data at a rising edge of a clock signal CLKA inputted. The latched data is outputted as the control signal Sset from a Q port of the flip-flop FF1 to the external resistance R1. When a reset signal Sreset outputted from a microcomputer (not shown) is inputted into an R port of the flip-flop FF1, the latched data is reset. The control terminal PDisb constitutes a control signal supply unit. The flip-flop FF1 and the resistance R1 constitute a control signal supply circuit.

Upon occurrence of an abnormality such as load shorting, the control signal Sset is a disabled state of “Low” level. Otherwise (in a ordinary operating state), the control signal Sset is an enabled state of “High” level.

The I/V converter circuit 23 is provided with a diode D1, a diode D2, an NPN transistor NT1, an NPN transistor NT2, a PNP transistor PT1, a PNP transistor PT2, and a resistance R2.

When the control signal Sset inputted through the control terminal PDisb is in an enabled state (at “High” level), the I/V converter circuit 23 converts a current flowing through the resistance R1 connected to the control terminal PDisb into voltage. An I/V-converted signal is outputted from a node N13. When the control signal Sset is in a disabled state (at “Low” level), the I/V converter circuit 23 does not perform the I/V conversion on the control signal Sset. Accordingly, a signal is not outputted from the node N13 in such a case. The I/V converter circuit 23 constitutes a voltage output circuit.

An anode of the diode D1 is connected to the node N7, while that of the diode D2 is connected to a cathode of the diode D1. A cathode of the diode D2 is connected to a node N11.

A collector of the NPN transistor NT1 is connected to the node N11. A base of the NPN transistor NT1 is connected to the collector (that is, to the node N11). An emitter of the NPN transistor NT1 is connected to the lower voltage supply (ground potential) Vss. A collector of the NPN transistor NT2 is connected to the node N12. A base of the NPN transistor NT2 is connected to the base of the NPN transistor NT1. An emitter of the NPN transistor NT2 is connected to the lower voltage supply (ground potential) Vss. The NPN transistors NT1 and NT2 form a current mirror circuit.

An emitter of the PNP transistor PT1 is connected to the higher voltage supply Vcc. A collector of the PNP transistor PT1 is connected to a node N12. Abase of the PNP transistor PT1 is connected to the collector, i.e. to the node N12. An emitter of the PNP transistor PT2 is connected to the higher voltage supply Vcc. A collector of the PNP transistor PT2 is connected to the node N13. A base of the PNP transistor PT2 is connected to the base of the PNP transistor PT1. The PNP transistors PT1 and PT2 form a current mirror circuit. One terminal of the resistance R2 is connected to the node N13. The other terminal of the resistance R2 is connected to the lower voltage supply (ground potential) Vss.

The sample hold circuit 24 is provided with a switch SW1 and a capacitor C1. The switch SW1 has one terminal connected to the node N13 and the other terminal to a node N14. The switch SW1 performs ON/OFF operation based on a signal of the node N8. One terminal of the capacitor 14 is connected to the node N14. The other terminal of the capacitor 14 is connected to the lower voltage supply (ground potential) Vss.

The sample hold circuit 24 receives the I/V-converted signal from the node N13 when the control signal Sset is in an enabled state (at “High” level). Charge is accumulated in the capacitor C1 by the signal inputted. The sample hold circuit 24 is a voltage hold circuit.

The soft shutdown circuit 25 is provided with an N-channel MOS transistor NMT3, a resistance R3, a resistance R4, and a switch SW2.

One terminal of the switch SW2 is connected to the node N14. the other terminal of the switch SW2 is connected to a node N15. The switch SW2 performs ON/OFF operation based on a signal of the node N9. One terminal of the resistance 3 is connected to the node N15.

The other terminal of the resistance R3 is connected to the lower voltage supply (ground potential) Vss. A drain of the N-channel MOS transistor NMT3 is connected to the node N6. A gate of the N-channel MOS transistor NMT3 is connected to the node N15. A source of the N-channel MOS transistor NMT3 is connected to one terminal of the resistance R4.

A relatively high voltage MOS transistor is used for the N-channel MOS transistor NMT3. The resistance 4 is connected to the lower voltage supply (ground potential) Vss.

The soft shutdown circuit 25 receives a signal of the node N14 outputted from the sample hold circuit 24 when the control signal Sset is in a disabled state (at “Low” level) upon occurrence of an abnormality such as load shorting.

The N-channel MOS transistor NMT3 is turned “ON” until the charges accumulated in the capacitor C1 of the sample hold circuit 24 are discharged.

This causes current on the output side of the output unit 2a of the power device drive system 50 to be drawn out, so as to put the IGBT 4 connected to the Vo terminal PVo to soft shutdown state.

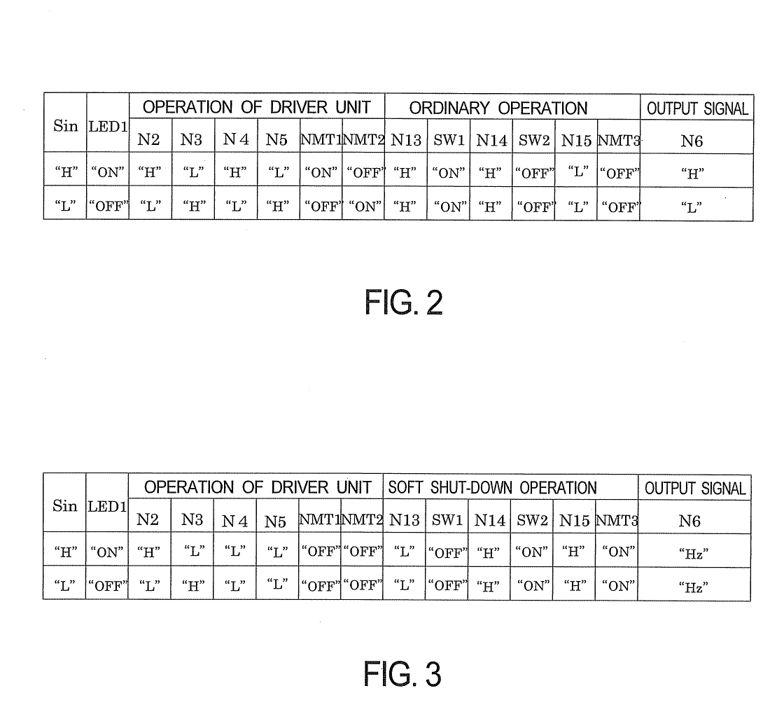

Operation of the power device drive system 50 according to the first embodiment of FIG. 1 will be described with reference to FIGS. 2 and 3.

FIG. 2 is a drawing showing an ordinary operation of the power device drive system 50 when the control signal Sset is in an enabled state. FIG. 3 is a drawing showing soft shut down operation of the power device drive system 50 when the control signal Sset is in a disabled state.

FIG. 2 and FIG. 3 show states of respective components shown in FIG. 1. “H” represents “High” level, while “Low” represents “Low” level. “Hz” represents a high impedance state.

With reference to FIG. 2, operation of the power device drive 50 will be described. When the IGBT 4 is in ordinary operation and the control signal Sset is in an enabled state (at “High” level), current flows through the resistance R1. The switch SW1 of the sample hold circuit 24 is turned “ON”, and charges are accumulated in the capacitor C1.

As the switch SW2 of the soft shutdown circuit 25 is “OFF”, the soft shutdown circuit 25 does not operate.

Consequently, an output signal of the node N6 of the output unit 2a having the N-channel MOS transistors NMT1 and NMT2 is at “High” level when the input signal Sin is at “High” level. In addition, the output signal of the node N6 is at “Low” level when the input signal Sin is at “Low” level.

With reference to FIG. 3, the shutdown operation of the power device drive system 50 will be described. Upon occurrence of an abnormality such as load shorting, the control signal Sset shows a disabled state (at “Low” level). Both signals of the nodes N4 and N5 outputted from the disable circuit 22 are at “Low” level.

As a result, both the N-channel MOS transistors NMT1 and NMT2 are turned “OFF” and the node N6 on the output side of the output unit 2a shows Hz state (high impedance state).

A current does not flow through the resistance R1 so that the I/V converter circuit 23 stops its operation. Thus, the switch SW1 of the sample hold circuit 24 is turned “OFF”. The switch SW2 of the soft shutdown circuit is turned “ON”.

Consequently, the N-channel MOS transistor NMT3 of the soft shutdown circuit 25 is “ON” until the charges accumulated in the capacitor C1 of the sample hold circuit 24 are discharged. This causes current from the node N6 on the output side of the output unit 2a to be drawn out.

In other words, current is drawn out from the gate of the IGBT 4 where an abnormal state, such as load shorting, has occurred so that the IGBT 4 is put in a shutdown state.

In the embodiment, since the configuration described above enables the soft shutdown operation, it is not always necessary to connect an external resistance or an external transistor to the signal line connecting the Vo terminal PVo and the terminal Pad3 of the power device drive 50.

Therefore, the gate line of the IGBT 4 can be shortened. In addition, the number of components can be reduced.

In the embodiment, the N-channel MOS transistor NMT1 is provided on the higher voltage supply Vcc side of the output unit 2a, while the N-channel MOS transistor NMT2 is provided on the lower voltage supply (ground potential) Vss side.

Alternatively, the P-channel MOS transistor may be provided on the higher voltage supply Vcc side, while the N-channel MOS transistor may be provided on the lower voltage supply (ground potential) Vss. Still alternatively, a first P-channel MOS transistor may be provided on the higher voltage supply Vcc side, while a second P-channel MOS transistor may be provided on the lower voltage supply (ground potential) Vss side.

In such a case, it is preferable to change the circuit configuration of the disable circuit 22 and the driver 31, and to change a signal level of the node N4 and node N5, as appropriate.

On the output side of the sample hold circuit 24, a comparator may be provided as a voltage follower in which a signal of an output side of the comparator is fed back and inputted into a minus (−) port on an input side of the comparator.

In addition, although the IGBT 4 is used as a power device, a power MOS transistor may be used instead, depending on the voltage or current to be used. Although a bipolar transistor constitutes the I/V converter circuit 23 in the embodiment described above, a MOS transistor or an MIS transistor, for example, may be used instead.

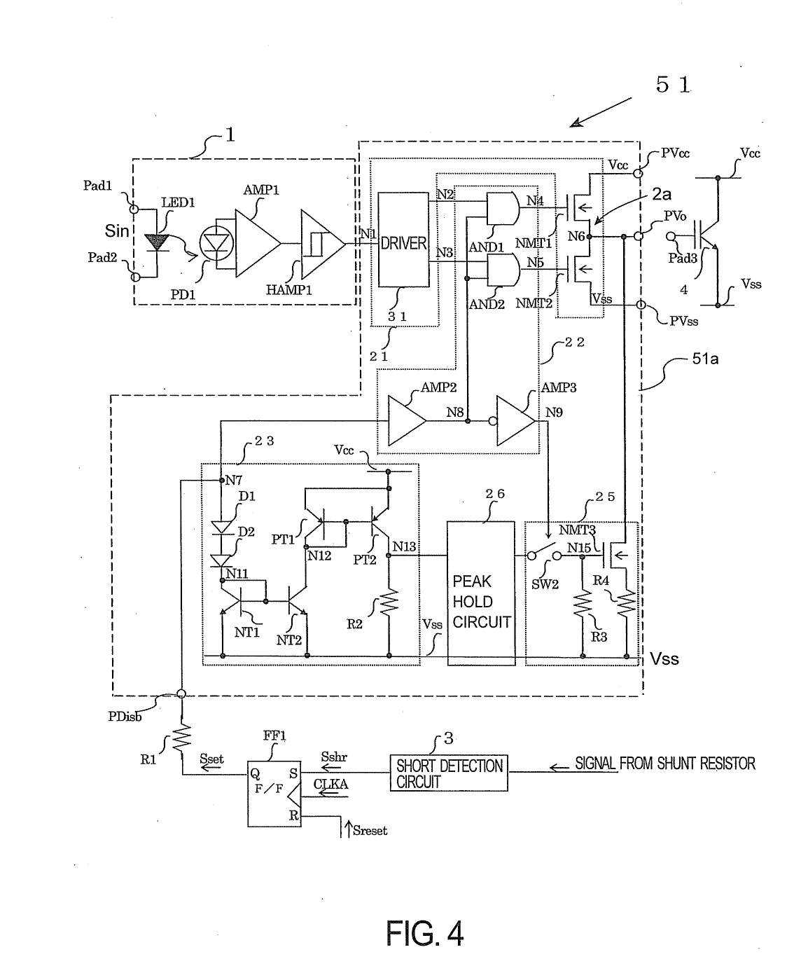

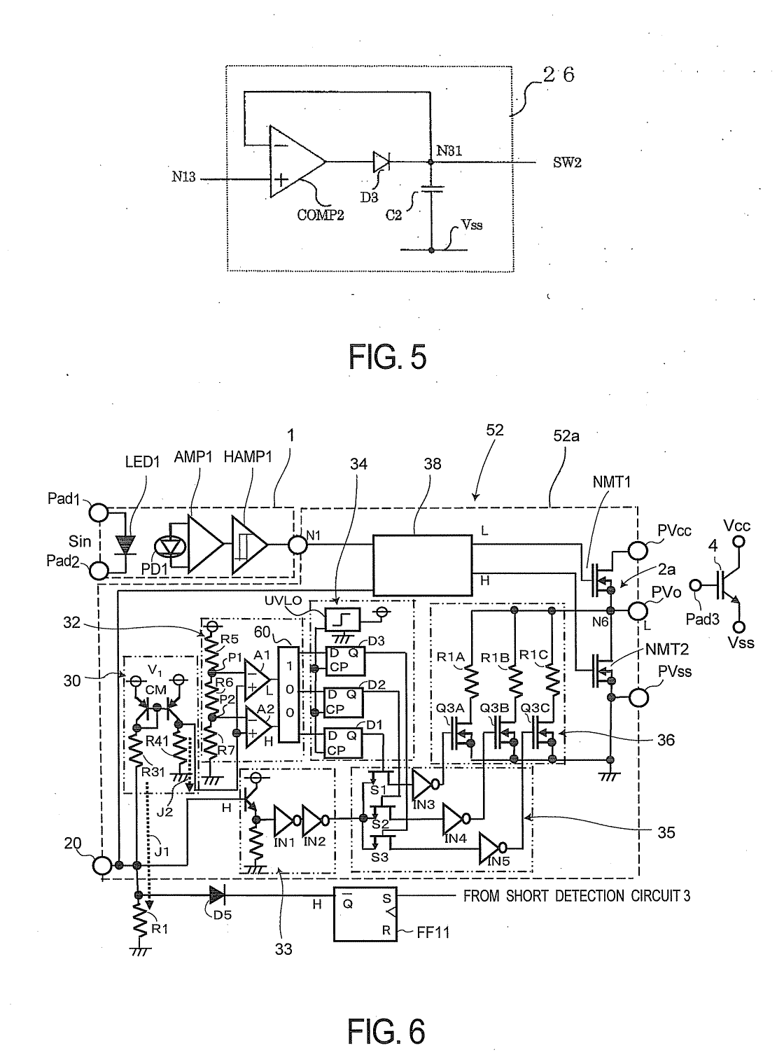

A power device drive system according to a second embodiment of the present invention will be described with reference to the drawings. FIG. 4 is a circuitry diagram showing the power device drive system according to the second embodiment. FIG. 5 is a circuitry diagram showing a specific example of the peak hold sample circuit of the power device drive system of FIG. 4. The power device drive system 51 is used in an HEV, for example.

In FIG. 4, the same components as those in FIG. 1 are denoted by the same symbols.

As shown in FIG. 4, the optical coupling unit 1 and a power device drive circuit unit 51a are provided in the power device drive system 51.

Similarly to the power device drive system 50 of FIG. 1, the power device drive circuit unit 51a is provided with the driver unit 2, the disable circuit 22, the I/V converter circuit 23, the soft shutdown circuit 25, the control terminal PDisb, the Vcc terminal PVcc, the Vo terminal PVo, and the Vss terminal PVss. The resistance R1, the flip-flop FF1 and the short detection circuit 3 are connected to the control terminal PDisb. The resistance R1, the flip-flop FF1 and the short detection circuit 3 are externally attached to the power device drive system 50.

Furthermore, a peak hold circuit 26 is provided in the power device drive system 51a.

The peak hold circuit 26 is connected between the I/V converter circuit 23 and the soft shutdown circuit 25. When the control signal Sset is in an enabled state (at “High” level), the peak hold circuit 26 receives an I/V-converted signal outputted from the node N13, and then holds the peak at a predetermined voltage. The peak hold circuit 26 constitutes a voltage hold circuit.

As shown in FIG. 5, the peak hold circuit 26 is provided with a capacitor C2, a comparator COMP2, and a diode D3.

A signal of the node N13 is inputted into a plus (+) port on the input side of the comparator COMP2. A signal of a node N31 is fed back and inputted into a minus (−) port on the input side of the comparator COMP2. The comparator COMP2 outputs a signal obtained by amplifying a difference between the signals respectively inputted into the both ports. An anode of the diode D3 is connected to an output terminal of the comparator COMP2. A cathode of the diode D3 is connected to the node N31.

One terminal of the capacitor C2 is connected to the node N31. The other terminal of the capacitor C2 is connected to the lower voltage supply (ground potential) Vss. The one terminal of the capacitor C2, i.e. the node N31, is connected to the switch SW2 of the soft shutdown circuit 25. When the control signal Sset is in an enabled state (at “High” level), the capacitor C2 receives an I/V-converted signal outputted from the node N13, and then accumulates charges.

In the soft shutdown circuit 25, upon occurrence of an abnormality such as load shorting, the control signal Sset shows a disabled state (at “Low” level). When the disable circuit 22 receives the control signal Sset in the disabled state, a signal outputted from the output unit 2a is to be in a high impedance state.

On the one hand, an output signal of the peak hold circuit 26 is inputted into the soft shutdown circuit 25. The N-channel MOS transistor NMT3 is “ON” until the charges accumulated in the capacitor C2 of the peak hold circuit is discharged. As a result, current on the output side of the output area 2a is drawn out, which puts the IGBT 4 connected to the Vo terminal PVo to a soft shutdown state.

As the embodiment described above enables soft shutdown operation, as the first embodiment, it is not always necessary to connect an external resistance or an external transistor to the signal line connecting the Vo terminal PVo and the terminal Pad3 of the power device drive system 50.

Thus, a gate line of the IGBT 4 can be shortened. In addition, the number of components can be reduced.

In the second embodiment described above, a comparator as a voltage follower may be provided on the output side of the peak hold circuit 26. In the case, a signal on an output side of the comparator may fed back and inputted into a minus (−) port of the comparator.

A power device drive system according to a third embodiment of the present invention will be described with reference to the drawings. FIG. 6 is a circuitry diagram showing a power device drive system according to the third embodiment. In FIG. 6, the same components as those in FIG. 1 are denoted by the same symbols respectively.

An optical coupling unit 1 and a power device drive circuit 52a are provided in the power device drive system 52. The power device drive circuit 52a includes an I/V converter circuit 30, an A/D converter circuit 32, a monitor circuit 33, a memory circuit 34, a switching circuit 35, a soft shutdown circuit 36, N-channel MOS transistors NMT1 and NMT2 constituting an output unit 2a, and a driver 38 to drive the N-channel MOS transistors NMT1 and NMT2.

In addition, the power device drive circuit 52a has a node N1, a Vcc terminal PVcc, a Vo terminal PVo, a Vss terminal PVss, and an abnormality detection terminal 20. The resistance R1 is connected to the abnormality detection terminal 20. The abnormality detection terminal 20 constitutes a control signal supply unit.

The I/V converter circuit 30 is a voltage output circuit that outputs voltage according to a control signal from the abnormality detection terminal 20.

When a power device as a load is the IGBT 4, control voltage is applied to the control electrode Pad3 of the IGBT 4 through the Vo terminal PVo. In addition, when overcurrent is detected in an ON state of the IGBT 4, an abnormal signal is inputted into a reset-set flip-flop FF11. Output of the reset-set flip-flop FF11 is transmitted to the abnormality detection terminal 20 through the diode D5. The reset-set flip-flop FF11, a diode D5, and the resistance R1 constitute a control signal supply circuit. An input signal for switching ON and OFF of the IBGT 4 is inputted into the node N1.

Structures and operations of the respective blocks of the power device drive circuit 52a will be described below. The driver 38 receives an output signal of either “High” level (H level) or “Low” level (L level) from the optical coupling unit 1 through the node N1. The driver 38 receives a signal from the abnormality detection terminal 20.

Outputs of the driver 38 are respectively supplied to gates of the N-channel MOS transistors NMT1 and NMT2 of the output unit 2a. A connecting point N6 of a source of the N-channel MOS transistor NMT1 and a drain of the N-channel MOS transistor NMT2 is connected to the Vo terminal PVo. A drain of the MOS transistor NMT1 is connected to the Vcc terminal PVcc, and a source of the N-channel MOS transistor NMT2 is connected to the Vss terminal PVss.

FIG. 6 shows a state where a signal is not inputted into a light emitting diode LED1. In addition, as a control signal being supplied from the driver 38 to the N-channel MOS transistor NMT1 is at L level, the N-channel MOS transistor NMT1 is in OFF state. In addition, as a control signal being supplied to the N-channel MOS transistor NMT2 is at H level, the N-channel MOS transistor NMT2 is in ON state. Thus, the Vo terminal PVo is at L level. As a control signal being inputted from the Vo terminal PVo into the IGBT 4 is at L level, the IGBT 4 is in OFF state.

The soft shutdown circuit 36 includes MOS transistors Q3A, Q3B, and Q3C, and shutdown resistances R1A, R1B, and R1C for performing soft shutdown. Series circuits formed of the MOS transistors Q3A, Q3B, and Q3C and the shutdown resistances R1A, R1B, and R1C, respectively, are connected in parallel.

The I/V converter circuit 30 includes a current mirror CM formed of a pair of bipolar transistors, and resistances R31 and R41. Internal voltage V1 is supplied to the current mirror CM. The abnormality detection terminal 20 is at H level.

The A/D converter circuit 32 includes serially-connected resistances R5, R6, and R7 that generate comparison voltages. In addition, the A/D converter circuit 32 has A/D converters A1 and A2. The A/D converters A1 and A2 compare analog voltage outputted from the I/V converter circuit 30 with one of the comparison voltages generated by the resistances R5, R6, and R7, so as to rank the analog voltage according to its voltage level. The A/D converters A1 and A2 output a digital signal corresponding to the rank. The A/D converter circuit 32 further includes an encoder 60 that converts the digital signal into three (3) bits.

Current J1 flowing through the external resistance R1 is converted into voltage by the current mirror CM and the resistance R41. The converted voltage is inputted into positive input terminals of the A/D converters A1 and A2. In addition, the internal voltage V1 is 5 to 6V, for example. The internal voltage V1 is divided by the resistances R5, R6, and R7. Then, voltage obtained from a connecting point P1 of resistances R5 and R6 and voltage obtained from a connecting point P2 of resistances R6 and R7 are respectively inputted into negative input terminals of the A/D converter A1 and A2.

One of the resistances R1A, R1B, and R1C is selected as a shutdown resistance by comparing the voltages in the A/D converters A1 and A2, as will be described below.

In FIG. 6, output of the A/D converter A1 is at L level, while that of the A/D converter A2 is at H level. By varying a value of the external resistance R1, selection can be made among the shutdown resistances R1A, R1B, and R1C, so that soft shutdown can be adjusted. In this way, the abnormality detection terminal 20 functions not only for an abnormality detection, but also for soft shutdown adjustment.

The monitor circuit 33 transmits a signal from the abnormality detection terminal 20 to the soft shutdown circuit 36. In FIG. 6, as output of the reset-set flip-flop FF11 (Q-) is at H level, an input signal to the monitor circuit 33 is at H level. Existence of the diode D5 prevents current outputted from the reset-set flip-flop FF11 from flowing into the external resistance R1.

The memory circuit 34 is composed of three delay flip-flops D1, D2, and D3. An output signal of an undervoltage lockout circuit UVLO is supplied as a trigger signal to each of terminals CP of the delay flip-flops D1, D2, and D3.

When the supply voltage Vcc is below the operation guarantee range of the power device drive system 52, the Vo terminal PVo is forced to be at “Low” (L) level. Such a function of forcing an output terminal of a system to be at “Low” (L) level when a supply voltage Vcc is below an operation guarantee range is called as “Undervoltage Lockout”. In FIG. 6, when the supply voltage Vcc reaches near 10V within the operation guarantee range, the undervoltage lockout circuit UVLO generates a trigger signal, when the power device drive system 52 starts to operate.

A voltage V1, for example, 5V to 6V, which is lower than the operation guarantee range, is applied to the current mirror CM and the resistances R5, R6, and R7. By the application of the voltage V1, when the trigger signal is inputted into the terminals CP, a signal is inputted into the delay flip-flops D1, D2, D3 through their respective input terminals D.

When a first trigger (or clock) signal is inputted into each of the terminals CP of the delay flip-flops, a value of each of input terminals D of the delay flip-flops D1, D2, and D3 is a value of the output terminals Q. Until a second trigger signal is inputted into the terminals CP, the value of the input terminals D is held in the output terminals Q.

Thus, “0”, “0”, and “1” are respectively held in the output terminals Q of the delay flip-flops D1, D2, and D3 during the period between the first trigger signal and the second trigger signal. In the embodiment, though the number of delay flip-flops may be two as a value to be stored is two bits, the three delay flip-flops are provided because the three shutdown resistances are arranged.

The switching circuit 35 includes MOS transistors S1, S2, and S3 and inverters IN3, IN4, and IN5. Switching of the shutdown resistances R1A, R1B, and R1C to be connected is performed by that the MOS transistors S1, S2, and S3 receive output of the output terminals Q of the delay flip-flops and output of the monitor circuit 33 respectively.

One of the MOS transistors Q3A, Q3B, and Q3C turns on by receiving output from the switching circuit 35 to perform soft shutdown. The MOS transistors Q3A, Q3B, Q3C function as switches to select one among the shutdown resistances R1A, R1B, and R1C.

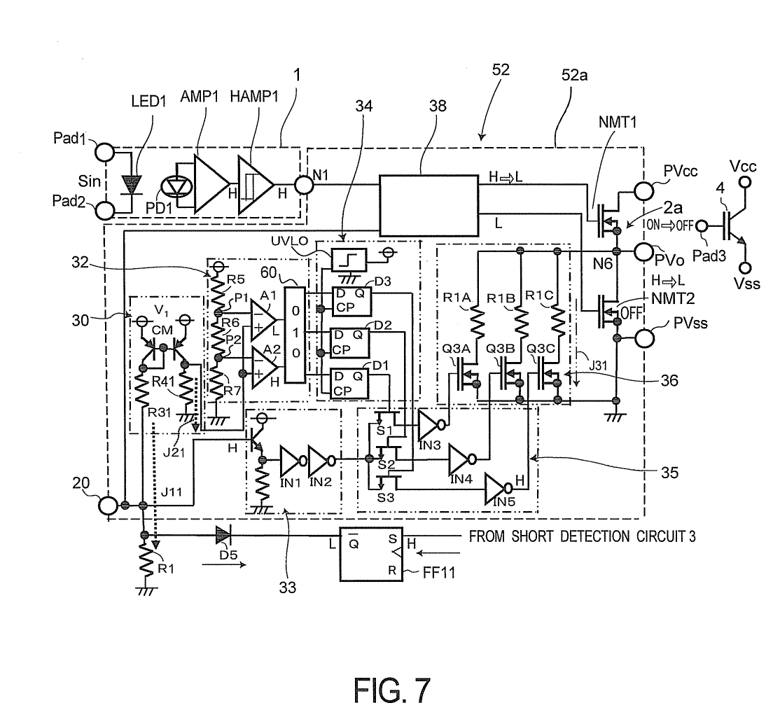

FIG. 7 is a circuitry diagram showing operation performed when an abnormality has been detected. An abnormality is detected when the IGBT 4 shows an abnormal state, such as a short, with the Vo terminal PVo at H level and in an ON state of the IGBT 4. An input S of the reset-set flip-flop FF11 is at H level. Output of the output terminal (Q-) is at L level. The diode D5 changes the abnormality detection terminal 20 from H level to L level.

The transition is transmitted to the driver 38, and a control signal to the N-channel MOS transistor NMT1, which has been at H level, is then changed to L level. This turns OFF the N-channel MOS transistor NMT1. As the N-channel MOS transistor NMT2 is OFF, the Vo terminal PVo shows a floating state.

The abnormality detection terminal 20 changes from H level to L level, and sources of the MOS transistors S1, S2, and S3 is set at L level by outputs of the inverters IN1 and IN2. As outputs of the output terminals Q of the delay flip-flops D1, D2, and D3 are “0”, “0”, and “1”, respectively, a signal from the MOS transistor S3, which is turned on, is supplied to the inverter IN5. As a result, the output of the inverter IN5 changes to H level.

Consequently, the MOS transistor Q3C of the soft shutdown circuit 36 is turned on, and the shutdown resistance R1C is connected between the Vo terminal PVo and the Vss terminal PVss. By the connection, the charges accumulated in the gate of the IGBT 4 are drawn out gradually, which enables soft shutdown. Thus, abrupt turn-off may be suppressed, and destroy of the IGBT 4 can be prevented.

Voltage of the abnormality detection terminal 20 being at L level is lowered to about the forward voltage of the diode D5. A current J11 flowing through the current mirror CM increases beyond the current J1 flowing when the abnormality detection terminal 20 is at H level. The current J11 flows into the ground through the external resistor R1 and the terminal (Q-) of the reset-set flip-flop FF11 which has been changed to L level. The voltage change in the abnormality detection terminal 20 is transmitted through the I/V converter circuit 30 and the A/D converter circuit 32. The output of the A/D converter A1 is changed to H level.

As a result, the value of the input terminal D of the delay lip-flop D3 changes from “1” to “0” and that of the delay flip-flop D2 changes from “0” to “1”. However, as a second trigger signal is not inputted into the delay flip-flops D1, D2, and D3, outputs of the output terminals Q of the delay flip-flops D1, D2, and D3 remain unchanged and are held. Thus, no change is made in the ON/OFF states of the MOS transistors S1, S2, and S3. Accordingly, the selection of the shutdown resistance R1C is maintained without being changed, and the soft shutdown continues.

In the embodiment, the MOS transistors Q3A, Q3B, and Q3C of the soft shutdown circuit 36 and the shutdown resistances R1A, R1B, and R1C are provided in the power device drive circuit 52a, which enables integration in one chip.

Thus, the gate drive line of the IGBT 4 can be shortened, which facilitates miniaturizing the power device drive device 52. A shorter gate drive line of the IBGT 4 suppresses unbalanced operation of the IGBT 4. In addition, the number of components of the power device drive system can be reduced, which facilitates the miniaturization.

In the embodiment, a resistance value of each of the shutdown resistances R1A, R1B, and R1C can be selected. When a ratio of the resistance values of the shutdown resistances R1A, R1B, and R1C is set to 80:10:120, for example, a common power device drive system having the soft shutdown protection function can be provided to several types of IGBTs.

The number of shutdown resistances is not limited to three, and at least two shutdown resistances may be provided. Use of at least two shutdown resistances makes it possible to obtain a power device drive system having sufficient soft shutdown protection function in consideration of an allowable shape and dimension and system requirements.

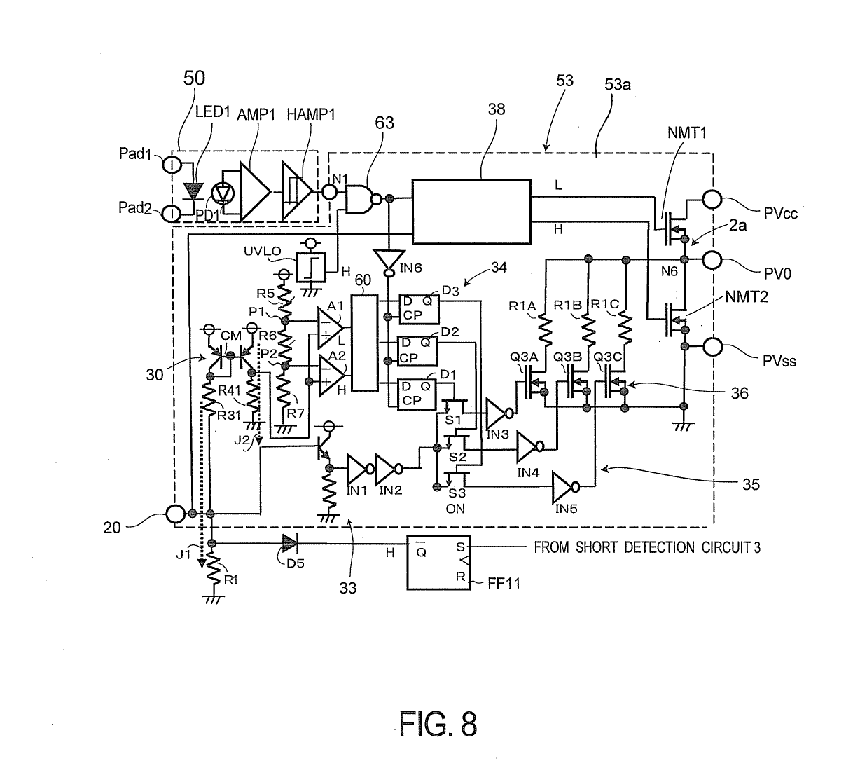

FIG. 8 is a circuitry diagram showing a power device drive system according to a fourth embodiment of the present invention. In FIG. 8, the same components as those in FIG. 6 are denoted by the same symbols.

In FIG. 8, a NAND circuit 63 receives an output signal of the photo-receiving diode PD1 that receives a signal from the light emitting diode LED1 and output of the undervoltage lockout circuit UVLO. After being inverted by an inverter IN6, output of the NAND circuit 63 is inputted into each of terminals CP of the delay flip-flops D1, D2, and D3 as a trigger signal.

In addition, output of the NAND circuit 63 is supplied to one input terminal of the driver 38 and used to control the driver 38. Similar to the third embodiment as shown in FIG. 6, a signal from the abnormality detection terminal 20 is supplied to the other input terminal of the driver 38.

Since an external resistance and an external transistor are not always needed, the embodiment may provide a power device drive system with soft shutdown protection function that is composed of a fewer number of components, which enable miniaturization. In addition, the IGBT can be prevented from destroying or suffering damage when the motor drive apparatus system including the IGBT 4 is subjected to high temperatures, for example.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A power device drive system for switching a power device, comprising:
a driver unit that includes a driver and an output unit, the driver receiving an input signal for switching the power device so as to output a driver output signal, the output unit being connected between a higher voltage supply and a lower voltage supply, the output unit having first and second transistors connected in cascade, the first and second transistors being controlled according to the driver output signal to output a drive signal for driving the power device,
a control signal supply portion to supply a control signal for indicating an enabled state and a disabled state so as to control the first and second transistors;
a disable circuit to turn off the first and second transistors when the control signal from the control signal supply portion is in the disabled state;
a voltage output circuit to receive the control signal from the control signal supply portion so as to output a first signal for providing voltage according to the control signal;
a voltage hold circuit to receive the first signal outputted from the voltage output circuit and a signal corresponding to the control signal, the voltage hold circuit holding a voltage of the first signal to output a second signal of the held voltage when the control signal is in the disabled state; and
a shutdown circuit to receives the second signal outputted from the voltage hold circuit and a third signal obtained by inverting the control signal when the control signal is in the disabled state, the shutdown circuit drawing out current from an output terminal of the output unit while the second signal is supplied from the voltage hold circuit.

2. The power device drive system according to claim 1, further comprising a resistance connected to the control signal supply portion, wherein current flows through the resistance according to the control signal.

3. The power device drive system according to claim 2, wherein the voltage output circuit is a current/voltage converter circuit.

4. The power device drive system according to claim 1, wherein the voltage hold circuit is a sample hold circuit.

5. The power device drive system according to claim 4, wherein the sample hold circuit includes:
a first switch receiving the first signal outputted from the voltage output circuit, the first switch being turned on by the signal corresponding to the control signal; and
a first capacitor connected to the first switch.

6. The power device drive system according to claim 1, wherein the voltage hold circuit is a peak hold circuit.

7. The power device drive system according to claim 6, wherein
the peak hold circuit includes a first comparator, a first diode and a second capacitor, one input terminal of the first comparator receiving the first signal, an anode of the first diode is connected to an output terminal of terminal d of the first comparator and to the shutdown circuit, one terminal of the second capacitor is connected to the cathode of the first diode, and the other terminal of the second capacitor is connected to the lower voltage supply, the second capacitor outputting the second signal to the soft shutdown circuit.

8. The power device drive system according to claim 1 wherein
the enabled state and the disabled state of the control signal are a high-level state and a low-level state, respectively.

9. The power device drive system according to claim 1, wherein the shutdown circuit includes:
a second switch to receive the second signal from the voltage hold circuit, the second switch being switched based on the third signal; and
a third transistor provided between the output terminal of the output unit and the lower voltage supply, a gate of the third transistor gate being connected to the second switch.

10. The power device drive system according to claim 1, wherein
the drive output signal of the driver includes first and second driver output signals, and wherein the disable circuit includes:
a first amplifier to amplify the control signal to output the resultant signal to the voltage hold circuit;
a second amplifier to output the third signal obtained by inverting an output signal of the first amplifier;
a first AND circuit to output a signal obtained by performing an AND logical operation on the output signal of the first amplifier and the first driver output signal to a gate of the first transistor; and
a second AND circuit to output a signal obtained by performing an AND logical operation on the output signal of the first amplifier and the second driver output signal to a gate of the second transistor.

11. The power device drive according to claim 1, wherein the first, second, and third transistors are N-channel MOS transistors.

12. The power device drive system according to claim 1, further comprising an optical coupling unit to couple a light emitting device and a photo-receiving device, wherein
the input signal for switching the power device is provided through the light emitting device and the photo-receiving device.

13. A power device drive system for switching a power device, comprising:
a driver unit having a driver and an output unit, the driver receiving an input signal for switching the power device1 so as to output a driver output signal, the output device being connected between a higher voltage supply and a lower voltage supply, the output device having first and second transistors connected in cascade, the first and second transistors being controlled according to the driver output signal so as to output a drive signal for driving the power device;
a control signal supply portion to supply a control signal for controlling the first and second transistors;
a voltage output circuit to output voltage according to the control signal from the control signal supply portion;
an A/D converter circuit to rank the voltage obtained from the voltage output circuit according to the level of the voltage, the A/D converter circuit converting the voltage into a digital signal corresponding to the rank;
a memory circuit to hold the digital signal upon receipt of a trigger signal while the digital signal is received;
a shutdown circuit having shutdown resistances to be selected based on the digital signal held in the memory circuit, the shutdown circuit executing shutdown of the power device by connecting selected one of the shutdown resistances between an output terminal of the output unit and the lower voltage supply electrically.

14. The power device drive according to claim 13, wherein
the shutdown circuit further includes third transistors to be selected by the digital signal held in the memory circuit, the third transistors being connected in cascade to the respective shut down resistances to form first series circuits, one terminal of each of the first series circuits is connected to an output terminal of the output unit, the other terminal of each of the first series circuit is grounded.

15. The power device drive system according to claim 14, further comprising a switching circuit including second series circuits, each of second series circuits having a fourth transistor and an inverter connected in cascade, wherein the second series circuits of the switching circuit provide the third transistors of the shutdown circuit with a selection signal based on the digital signal held in the memory circuit.

16. The power device drive system according to claim 13, wherein the A/D converter circuit further includes an encoder to convert the number of bits of the digital signal.

17. The power device drive system according to claim 13, further comprising a resistance connected to the control signal supply portion, wherein current flows through the resistance according to the control signal.

18. The power device drive system according to claim 15, wherein
the memory circuit includes delay flip-flops,
the delay flip-flops receiving the digital signal from the A/D converter circuit, the delay flip-flops holding the digital signal to supply the held voltage to the fourth transistors, respectively upon receipt of the trigger signal.

19. The power device drive system according to claim 13, further comprising a NAND circuit, wherein
the input signal for switching the power device is supplied to one input terminal of the NAND circuit, and
the trigger signal is supplied to another input terminal of the NAND circuit, and
output of the NAND circuit is inputted into the driver, the output of the NAND circuit being supplied to the delay flip-flops through an inverter.

20. The power device drive system according to claim 13, further comprising an optical coupling unit to couple a light emitting device and a photo-receiving device, wherein
the input signal for switching the power device is provided through the light emitting device and the photo-receiving device.
